(19) United States
(12) Patent Application Publication
(10) Pub. No.: US 2007/0083567 A1
(43) Pub. Date: Apr. 12, 2007

(54) Storage control system and method

(76) Inventors: Masahiro Arai, Kawasaki (JP); Naoto Matsunami, Hayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/290,469

(22) Filed: Dec. 1, 2005

(30) Foreign Application Priority Data
Oct. 7, 2005 (JP) 2005-295025

(51) Int. Cl. G06F 17/30

(52) U.S. Cl. 707/200

(57) ABSTRACT

Data can be recovered at the point in time when the consistency is provided, without increasing a load on the host.

The control program 118 updates the snapshot generation at the point in time when the snapshot is taken for each occurrence of the point in time when the snapshot is taken. In cases where new data are written into PVOL1 from the point in time when the snapshot has been taken until the next point in time when the snapshot is taken, the old data are saved by the CoW in DVOL1 and new data are written into PVOL1. Each time new data are written into PVOL1, the update differential data, which are the copy of this data, are prepared and written into DVOL1. The opportunity of providing the consistency of PVOL1, which occurs independently of the operations of the user of the host computer 20, is taken and the update differential generation, which is the generation of update differential data at each point in time where the update differential data has been set, is updated each time the opportunity is taken. The recovery of PVOL1 is conducted based on the managed update differential generation and snapshot generation.

### CROSS-REFERENCE TO PRIOR APPLICATION

This application relates to and claims priority from Japanese Patent Application No. 2005-295025, filed on Oct. 7, 2005 the entire disclosure of which is incorporated herein by reference.

### BACKGROUND OF THE INVENTION

1. Field of the Invention

The present invention relates to storage control technology, and more particularly to backup and recovery.

2. Description of the Related Art

Disk array devices comprising a plurality of arranged disk storage devices (for example, hard disk drives) are known. Two or more logical volumes are prepared in a plurality of disk storage devices. A disk array device receives a command sent from a host computer, and following this command, writes data received from the host computer or reads data from logical volumes and transmits the data to the host computer.

A RAID (Redundant Array of Independent Disks) technology is generally employed in disk array devices. Furthermore, several technologies for providing data backup in order to prevent the loss of data are used in disk array devices.

One of them is the technology called “snapshot” (referred to hereinbelow as snapshot technology). The snapshot technology is a method of holding an image (snapshot) of a first logical volume at a certain point in time. A snapshot can be taken by saving old data prior to updating (referred to hereinbelow as old data) from a first logical volume to a second logical volume when new data is written into the first logical volume from a point in time where an opportunity designated by the user occurs (in other words, a point in time desired by the user), so as to enable the recovery of data present at this point of time. This processing is sometimes called Copy-on-Write (abbreviated hereinbelow as “CoW”). When data are recovered in the snapshot technology, a disk array device can write the CoW data present at the point in time desired by the user back from the second logical volume to the first logical volume. Such a snapshot technology is sometimes called PIT (Point In Time) technology because recovery is possible only at the point in time designated by the user.

The technology called journaling (referred to hereinbelow as journaling technology) is an example of another technology for data backup. With the journaling technology, a disk array device can record a log (hereinbelow called “journal log”) comprising a write command and data that are written anew following this command in the prescribed recording area (for example, a logical volume) each time the write command and data are received. With the journaling technology, a disk array device handles all the received write commands and data as journal logs. Therefore, recovery is possible at any point in time of a plurality of points in time in which the write command was received. For this reason, this technology is sometimes canned a CDP (Continuous Data Protection) technology. However, with this technology, a point in time called a check point (point in time the consistency has been provided) has to be provided from the user to the disk array device, similarly to the snapshot, in order to return to the data provided with consistency for a computer program (for example, an application program operating on the OS of the host computer) that is used by the user.

Technology disclosed in Japanese Patent Application Laid-open No. 2005-18738 is an example of another existing technology. With this technology, data at any point in time are recovered by combining a snapshot of a logical volume with the history of writing to this logical volume.

However, with any conventional technology, the user has to designate the point in time desired by the user in order to conduct recovery to the past point in time where consistency of data was provided. For this reason, if snapshots are to be taken frequently, the user has to designate frequently the snapshots, that is, the points in time corresponding to recovery points. This results in an increased load on a host computer employed by the user. Furthermore, if the frequency of snapshots is increased to realize them with CoW, the number of CoW cycles increases accordingly and the access performance is degraded (for example, a long time passes from the instant the write command is received to the instant the data writing is completed).

On the other hand, with the journaling technology, performance degradation of access to the first logical volume is inhibited by recording a journal log in the second logical volume, which is separated from the first logical volume where data are written following the write command from the host computer. However, a journal log comprising a write command and data has to be kept each time the write command and data are received and a large storage capacity is required. Furthermore, because data recovery requires that the data be sequentially recovered in an order inverted with respect to that of the write command processing, a long time is required for the recovery. A method in which a user frequently provides a check point indication to a disk array device can be considered for shortening the recovery interval, but this apparently increases a load on the host computer, in the same manner as with the snapshot technology.

A technology of using a write history together with a snapshot is also disclosed in Japanese Patent Application Laid-open No. 2005-18738. However, with this technology, too, data have to be regenerated in the order following the write history with reference to a point in time a snapshot is taken. Furthermore, because the snapshots have to be taken frequently in order to reduce the regeneration quantity of data, the above-described problem of increased load on the host computer is not resolved.

### SUMMARY OF THE INVENTION

It is an object of the present invention to enable the recovery of data at the point of time where consistency was provided, without increasing a load on the host.

It is another object of the present invention to reduce the storage capacity necessary for data backup.

Other objects of the present invention will become clear from the following description.

The storage system in accordance with the present invention comprises a first logical volume into which data from a host computer are written, a second logical volume, which is a logical volume for backup of the first logical volume, and a controller for writing data following a write command from the host computer into the first logical volume. The controller manages a snapshot generation, which is the generation of a snapshot at each point in time when the snapshot is taken. Furthermore, the controller updates the snapshot generation for each occurrence of point in time when the snapshot is taken. The controller also determines whether or not a write destination of new data is the location that has become the write destination for the first time after the point in time when the snapshot is taken in cases where the new data are written into the first logical volume from the point in time when the snapshot has been taken until the next point in time when the snapshot is taken, and if the write destination is a location that has become the write destination for the first time, saves the old data that have been stored in the write destination from the write destination of the first logical volume into the second logical volume and writes the new data into the write destination. The controller then writes update differential data, which is a copy of the new data, into the second logical volume each time new data are written into the first logical volume. The controller also takes an opportunity (for example, receives a sync command issued from the operating system of said host computer) to provide the consistency of the first logical volume occurring independently of the operation of the user of the host computer. The controller also manages an update differential generation, which is the generation of the update differential data at each point in time when the update differential data is set. The controller also updates the update differential generation each time the opportunity is taken. The controller then conducts the recovery of the first logical volume based on the managed update differential generation and snapshot generation.

In the first mode of the present invention, the controller can manage the snapshot generation and the update sequence of the update differential generation. Furthermore, the controller can manage in which snapshot generation each saved old data has been saved. Furthermore, the controller can manage in which update differential generation each written update differential data has been written. Furthermore, the controller can select the update differential generation, which becomes the recovery object, from a plurality of update differential generations that are managed. Furthermore, the controller can select a snapshot generation immediately preceding the selected update differential generation from one or more of the snapshot generations that are managed. Furthermore, the controller can determine the old data saved in the selected snapshot generation. Furthermore, the controller can determine the update differential data written in the selected update differential generation. Furthermore, the controller can recover data located in the first logical volume at the point in time of updating in the selected update differential generation by transferring the determined old data from the second logical volume to the first logical volume and then transferring the determined update differential data from the second logical volume to the first logical volume. In this first mode, the controller can receive a recovery command from the host computer or a separate computer and take the recovery object as an update differential generation after updating at the point in time which is the closest to the point in time when the recovery command was received.

In the second mode of the present invention, the controller can determine whether or not the old data present in the second logical volume and the update differential data are identical and delete one data from the second logical volume if both are identical. In the second mode, the controller can delete the update differential data when the data are identical.

In the third mode of the present invention, the controller can receive a snapshot taking command (for example, a clear opportunity command (PIT opportunity command) from the user) from the host computer or another computer by manual operations and take the point in time when the snapshot taking command is received as the point in time when the snapshot is taken.

Each of the above-described processing operations carried out by the controller can be executed with respective means. Furthermore, each processing operation carried out by the controller can be executed by hardware circuits or a processor reading a computer program. Furthermore, a plurality of processing operations carried out by the controller may be conducted with one or a plurality of processors and may be conducted by allocating between a processor and hardware circuits.

With the present invention, data can be recovered at the point in time the consistency was provided, without increasing a load on the host.

### BRIEF DESCRIPTION OF THE DRAWINGS

FIG. 1 is a an explanatory drawing illustrating a schematic configuration example of the disk array device of one embodiment of the present invention.

FIG. 2A shows an external appearance of the disk array device shown in FIG. 1. FIG. 2B shows a configuration example of the disk array controller.

FIG. 3 is a schematic drawing representing an example of relationship between the disk device and the logical volume.

FIG. 4A shows a configuration example of a VOL configuration management table. FIG. 4B shows a configuration example of a VOL correspondence management table.

FIG. 5 shows schematically a relationship between PVOL1, PVOL2, and DVOL1 in the present embodiment;

FIG. 6A shows a configuration example of the empty block management list of DVOL1, and FIG. 6B shows a configuration example of block usage quantity management table of DVOL1;

FIG. 7A shows a configuration example of a CoW management bitmap used for managing the snapshots of PVOL1 and FIG. 7B shows an example of snapshot generation management list of PVOL1;

FIG. 8 shows an example of the update differential data management list of PVOL1;

FIG. 9A shows an example of a generation counter management table. FIG. 9B shows a configuration example of a snapshot-update differential history table;

FIG. 10 shows an example of a flowchart of processing conducted when a command is received from a host;

FIG. 11A shows an example of a flowchart of processing conducted when a snapshot command is received from a snapshot manager 202 of the host 20. FIG. 11B shows an example of a flowchart of processing conducted to reduce the usage quantity of the DVOL by deleting the overlapping portions of update differential data and CoW data;

FIG. 12 shows schematically the change of data with time on PVOL1 and DVOL1; and

FIG. 13 shows an example of flowchart of data recovery processing.

FIG. 14A illustrates an example of the pattern of generation bits of each node in the case where a consistency opportunity between two write commands is taken. FIG. 14B illustrates an example of the pattern of generation bits of each node in the case where a consistency opportunity between two write commands is not taken.

### DESCRIPTION OF THE PREFERRED EMBODIMENTS

An embodiment of the present invention will be described below in greater detail with reference to the appended drawings.

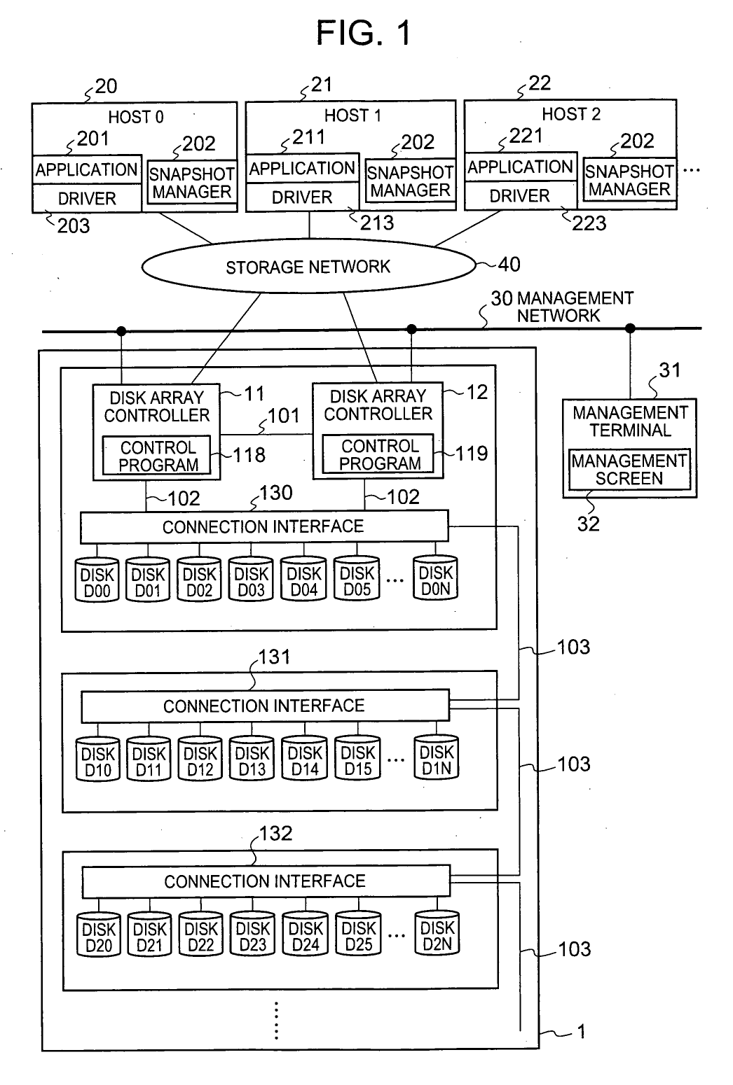

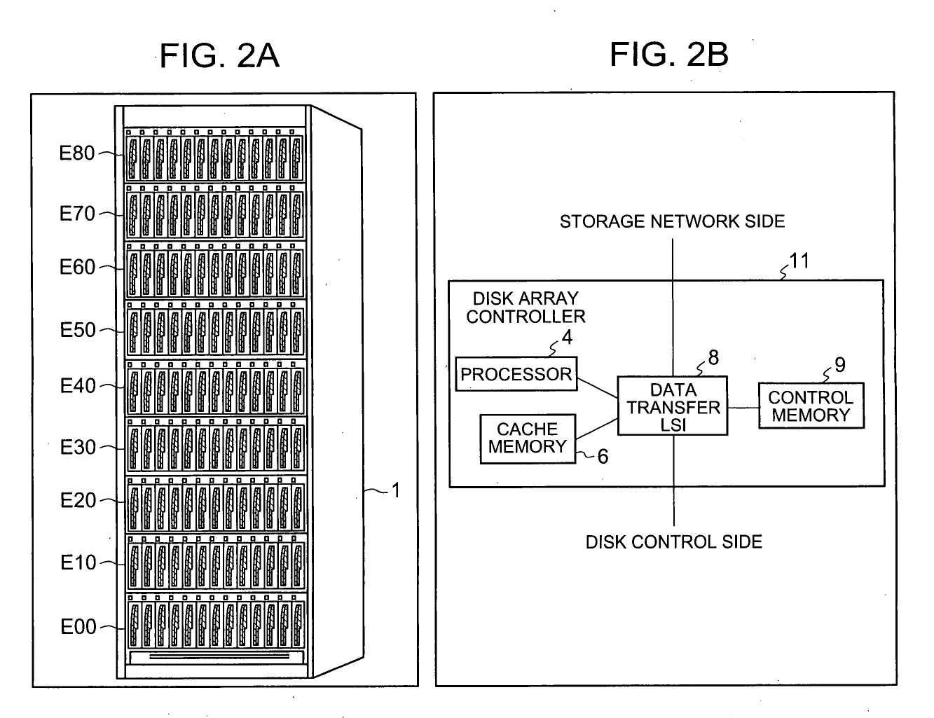

FIG. 1 is an explanatory drawing illustrating a schematic configuration example of a disk array device employing the storage system of the embodiment of the present invention. FIG. 2A illustrates an example of an external view of the display device shown in FIG. 1. FIG. 2B is a configuration example of the disk array controller.

The disk array device 1 comprises disk array controllers 11, 12, connection interfaces 130, 131, 132, and a plurality of disk storage devices (referred to hereinbelow as disk devices) D00-D2N. For example, as shown in FIG. 2A, the plurality of disk devices D00-D2N are installed in respective disk housings E00-E80 of the disk array device 1 and constitute a RAID group corresponding to the prescribed RAID level.

The disk array controllers 11, 12 are control circuits capable of executing control of various types in the disk array device 1, for example, by executing control programs 118, 119. The disk array controller 11 (disk array controller 12 is substantially identical thereto) can comprise, for example, as shown in FIG. 2B, a processor (for example, a CPU) 4 for reading and executing the control program 118, or a cache memory 6 capable of temporarily storing data transmitted between host computers (referred to hereinbelow simply as “hosts”) 20-21 and disk devices D00-D2N, or a LSI (Large Scale Integration) 8 for data transfer, or a memory (referred to hereinbelow as control memory) 9 capable of storing a variety of the below-described tables or lists, or a hardware accelerator chip (not shown in the figure) for accelerating the processing of the control programs 118, 119, or a variety of components (not shown in the figure) associated therewith. In the present embodiment, two disk array controllers 11, 12 are provided, but one or three and more disk array controllers may be also provided.

The disk array controllers 11, 12 are communicably connected to each other via a signal line 101. Furthermore, the disk array controllers 11, 12 are connected to hosts 20, 21, 22 via a storage network 40 and connected to a management terminal 31 via a management network 30. The storage network 40 is, for example, a FC-SAN (Storage Area Network) based on a fiber channel or a IP-SAN using a TCP/IP network. The management network 30 is, for example, a LAN (Local Area Network) using the TCP/IP network or a Point to Point network based on a serial cable.

The disk array controllers 11, 12 are connected to a plurality of disk devices D00-D2N via connection interfaces 130, 131, 132. For example, the connection interface 130 is connected to the disk array controllers 11, 12 via a signal line 102 and enables periodic communication. Furthermore, the connection interfaces 130, 131, 132 are connected to each other via a signal line 103. Therefore, the connection interface 131 is connected to the disk array controllers 11, 12 via the connection interface 130, and the connection interface 132 is connected via the connection interfaces 130, 131. The connection interface 130 is connected to a plurality of disk devices D00-D0N, the connection interface 131 is connected to a plurality of disk devices D10-D1N, and the connection interface 132 is connected to a plurality of disk devices D20-D2N.

A group comprising the connection interface 130 including the disk array controllers 11, 12 and a plurality of disk devices D00-D0N is called, for example, a base housing. A group comprising the connection interface 131 and a plurality of disk devices D10-D1N and a group comprising the connection interface 132 and a plurality of disk devices D20-D2N are called, for example, extension housings. As follows from FIG. 1, there may be 0 or 1, or 3 or more extension housings. In the present embodiment, the base housing is described as a group comprising the disk array controllers 11, 12, connection interface 130, and a plurality of disk devices D00-D0N, but a configuration in which the base housing does not contain a plurality of disk devices D00-D0N is also possible.

The hosts 20, 21, 22 are, for example, computers capable of inputting a variety of data. For example, they comprise a processor (for example, a CPU) capable of executing computer programs or a memory capable of storing computer programs or data. There may be one or more such hosts. A variety of application programs (referred to hereinbelow as applications) 201, 211, 221, for example, database software, text creating software, or mail server software operate in the hosts 20, 21, 22. A plurality of applications may operate in one host and one application may operate in a plurality of hosts. Data processed in the hosts 20, 21, 22 are sequentially sent to the disk array device 1 via drivers 203, 213, 223, which exchange data with the disk array device 1 and are stored in the disk array device 1. The drivers 203, 213, 223 can be control drivers of a host bus adapter (not shown in the figure) or multibus switching drivers.

Furthermore, a snapshot manager 202 also can operate, similarly to the applications 201, 211, 221, on the hosts 20, 21, 22. The snapshot manager 202 is a computer program and can issue an instruction to take a snapshot of the allocated logical volumes to a disk array device 1 based on the user's settings.

Each disk device D00-D2N is, for example, a hard disk drive. Hard disk drives conforming to a FC (Fiber Channel) standard, ATA (AT Attachment) standard, or SAS (Serial Attached SCSI) standard can be employed as the hard disk drive.

The management terminal 31 is a terminal unit (for example, a personal computer) used for executing maintenance management of the disk array device 1. The management terminal 31, for example, can comprise a CPU, a memory, and a management screen (for example, display device) 32. An administrator can control the state of the disk array device 1 via the management screen 32.

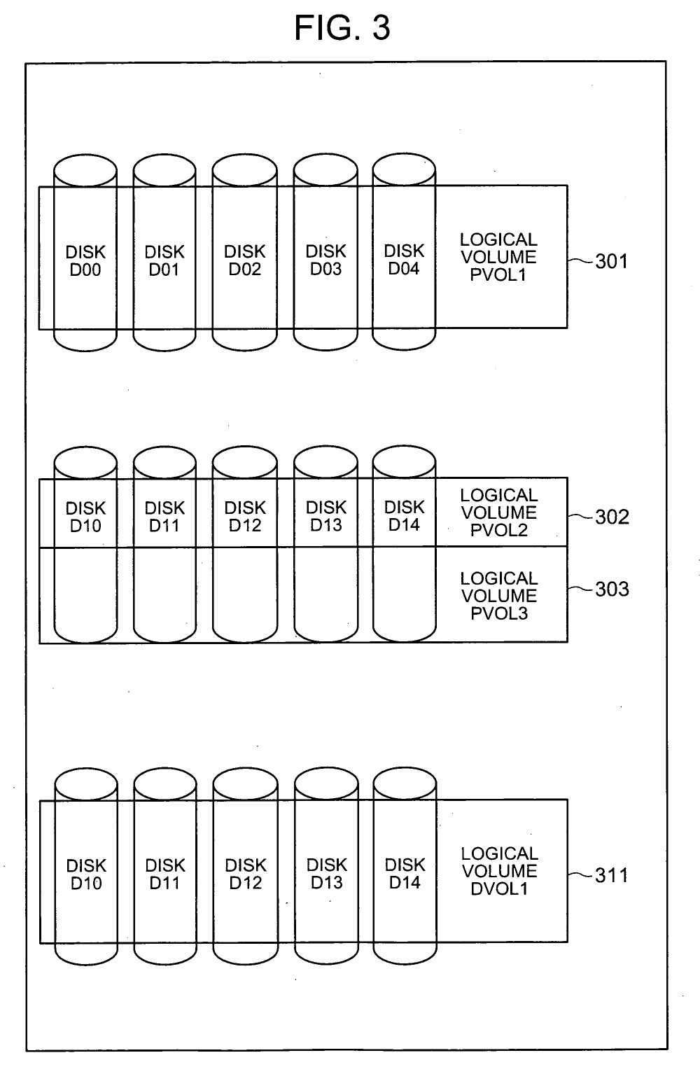

FIG. 3 is a schematic diagram illustrating a relationship example of disk devices and logical volumes.

The disk array device 1 has a RAID configuration based on a plurality of disk devices and can manage the storage areas provided by a plurality of disk devices in units of logical volumes (sometimes referred to hereinbelow simply as “VOL”). Logical volumes 301, 302, 303, 311 are constructed on the RAID constituted by using a plurality of disk devices. An administrator can confirm or set the logical volumes via the management terminal 31. Information relating to the configuration of logical volumes is kept by the disk array controllers 11, 12.

The VOL 301, 302, 303 are primary logical volumes (referred to hereinbelow simply as “primary volumes” or “PVOL”) and can store data exchanged between the hosts 20, 21, 22. The presence of three PVOL (PVOL1, PVOL2, and PVOL3) is hereinbelow assumed.

The logical volume 311 is a differential logical volume (referred to hereinbelow as “DVOL”). In the present invention, one DVOL1 is assumed, but a plurality of DVOL may be also used. The DVOL1 is a logical volume comprising a storage area (referred to hereinbelow as “pool area”) that can be dynamically used or freed. The DVOL1 is a logical volume for storing a local differential data block such as CoW data and can be used in association with any PVOL1, PVOL2, or PVOL3. The CoW data is the data prior to updating (that is, old data) in the PVOL1, PVOL2, or PVOL3, which is saved from PVOL to the DVOL with a CoW (Copy-on-Write). Furthermore, a block is a unit of commands issued by the OS (operating system) of the host computer.

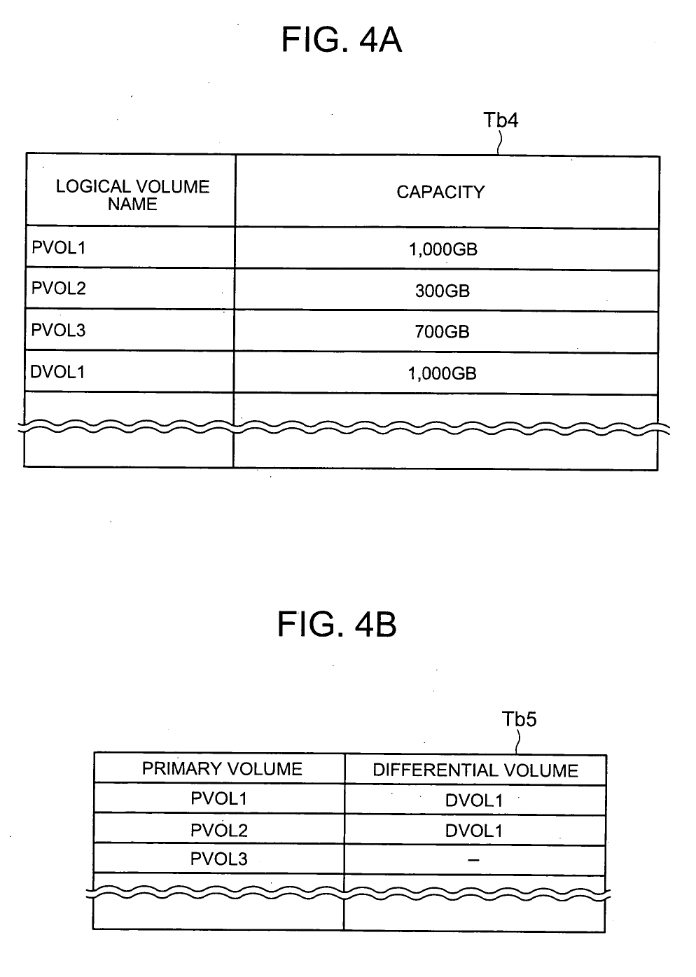

FIG. 4A shows a configuration example of a VOL configuration management table.

A VOL configuration management table Tb4 is a table for managing information (relating to the configuration of logical volumes (referred to hereinbelow as “VOL configuration information”). The VOL configuration information comprises a logical volume ID (for example, a name or a number), a storage capacity, a disk ID (a name or a number of the disk device comprising this VOL), and a RAID level for each VOL (not shown for the disk device ID and RAID level). For example, the PVOL1 301 has a volume name “PVOL1”, a storage capacity of 1000 GB, and a RAID level of “6” configured on the disk devices D00, D01, D02, D03, and D04.

FIG. 4B is a configuration example of a VOL correspondence management table.

A VOL correspondence management table Tb2 is a table for managing the relationship between a PVOL and a DVOL. If the processor 4, which executes the control programs 118, 119 (referred simply hereinbelow as “control programs 118, 119”), refers to this table Tb2, it can determine the preferred PVOL outputting the CoW data and the preferred DVOL for saving the data. With the table Tb2 shown as an example in FIG. 4B, it is clear that the DVOL1 is associated with the PVOL1 and PVOL2, whereas the PVOL3 is not associated with any DVOL.

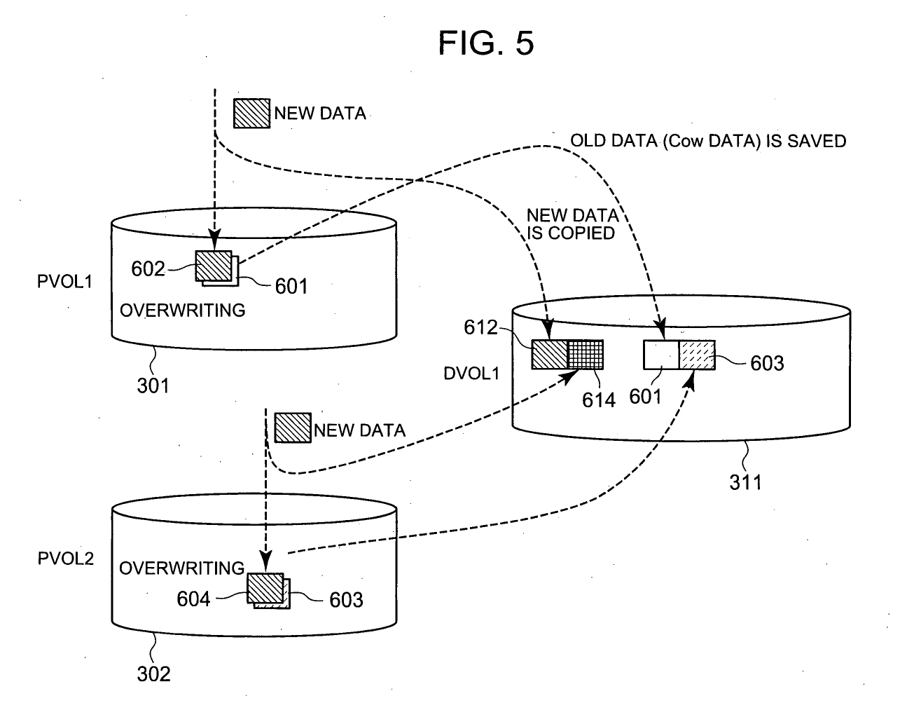

FIG. 5 shows schematically the relationship of PVOL1, PVOL2, and DVOL 1 in the present embodiment.

Data on the PVOL1, 2 are managed in block units. When data are updated in the PVOL1, 2, the blocks 601, 603 comprising the overwritten old data are saved by the control program 118 from the PVOL1, 2 into the DVOL1 associated therewith. Furthermore, copies 612, 614 of blocks 602, 604 comprising data (referred to hereinbelow as “new data”) that will be newly stored in the PVOL1, 2 are prepared by the control program 118 (for example, the blocks are duplicated on the cache memory 6), and the copies 612, 614 are stored in the DVOL1. The control program 118 manages the address relationship with the PVOL1, 2, and the data of the PVOL1, 2 can be stored in the empty block (unused block where no data are present) on the DVOL1.

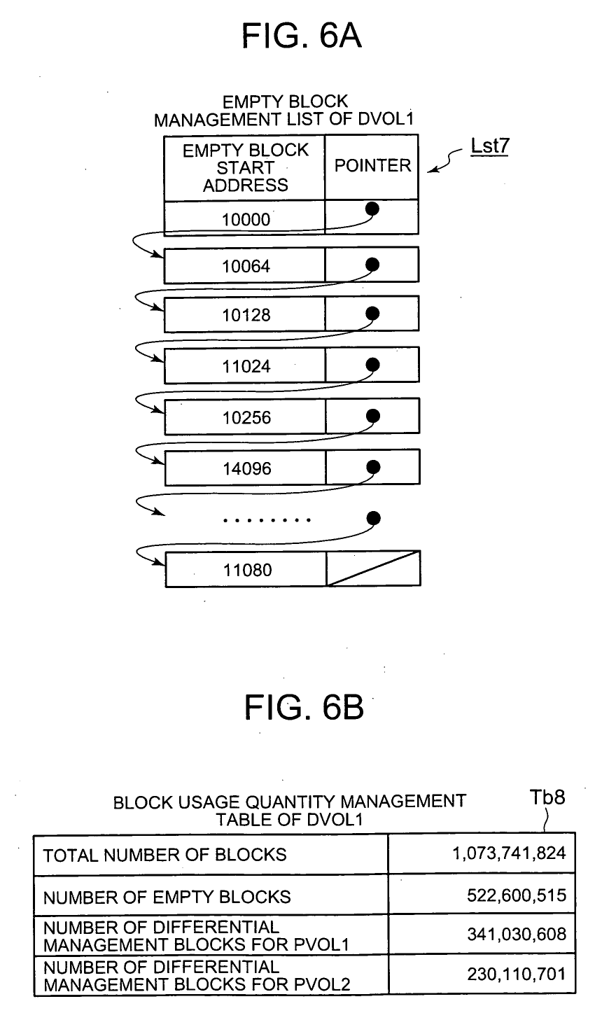

Management of the empty block in the DVOL1 will be explained below with reference to FIG. 6A. The reference symbol Lst7 shows an example of an empty block management list of DVOL1 (management can be similarly conducted with respect to other DVOL). The empty block list Lst7 is a linear list comprising a start address of an empty block (the address is, for example, a logical block address (LBA)) and a pointer to the next block. More specifically, for example, the start address of the very first empty block is 10000, and 10064 is indicated by a pointer as the start address of the next empty block.

The linear list can be also added to a block that was freed and can be reused (in other words, the above-described pool area). For example, because the block with a start address 11080 has been heretofore used, but then freed, it is added to the very end of the list. When no empty block follows the block with a start address 11080, a pointer is not used, as shown in FIG. 6A. In the present embodiment, the address of the block was expressed by 64 bytes, but the block can have any management size (for example, it can be expressed by 512 bytes).

The empty capacity of the DVOL1 is managed by a block usage quantity management table Tb8 shown by an example in FIG. 6B. For example, the total number of blocks, the number of empty blocks, and the number of blocks required for differential data management of each PVOL are recorded in the table 8b. The empty capacity can be found by multiplying the size per each block by the number of empty blocks. With the table 8b, the administrator can confirm the number of empty blocks and empty capacity of the DVOL1 through the management screen 32 of the management terminal 31.

The empty block list Lst7 and block usage quantity management table Tb8 of the DVOL1 were explained, but a similar list or table can be prepared for each DVOL.

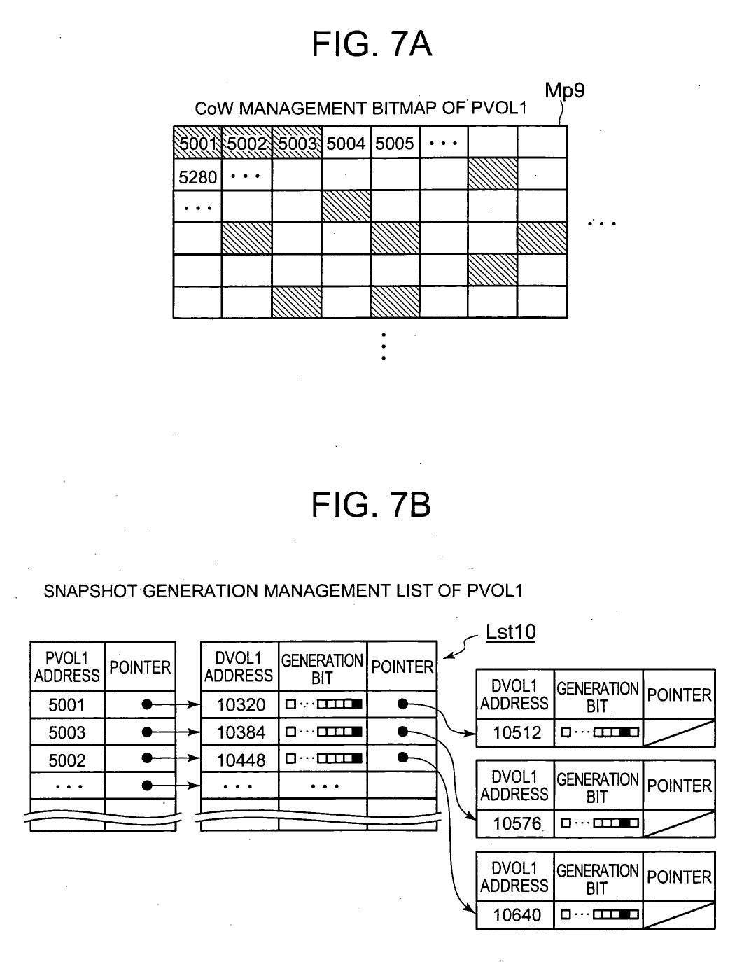

FIG. 7A shows a configuration example of a CoW management bitmap used for managing the snapshot of the PVOL1. Each bit corresponds to the address of a block on the PVOL1. The bit corresponding to the block where CoW was executed during new data overwriting is set ON (black color in the figure) by the control programs 118, 119, and other bits corresponding to other blocks are set OFF (white color in the figure). Snapshots of other PVOL can be managed by using similar bitmaps.

A snapshot generation management list of PVOL1 will be explained below with reference to FIG. 7B. A Lst10 is an example of the lists for managing the snapshot generation of PVOL1. In the Lst10, the correspondence of the block addresses on the PVOL1 and DVOL1 and the block address of the DVOL1 where the CoW data of each generation are stored are indicated with pointers. Each node (list element) serves as an address of block storing the data on the DVOL1, a bit group (referred to hereinbelow as “age bit”) indicating the generation of the data, and a pointer to the next node.

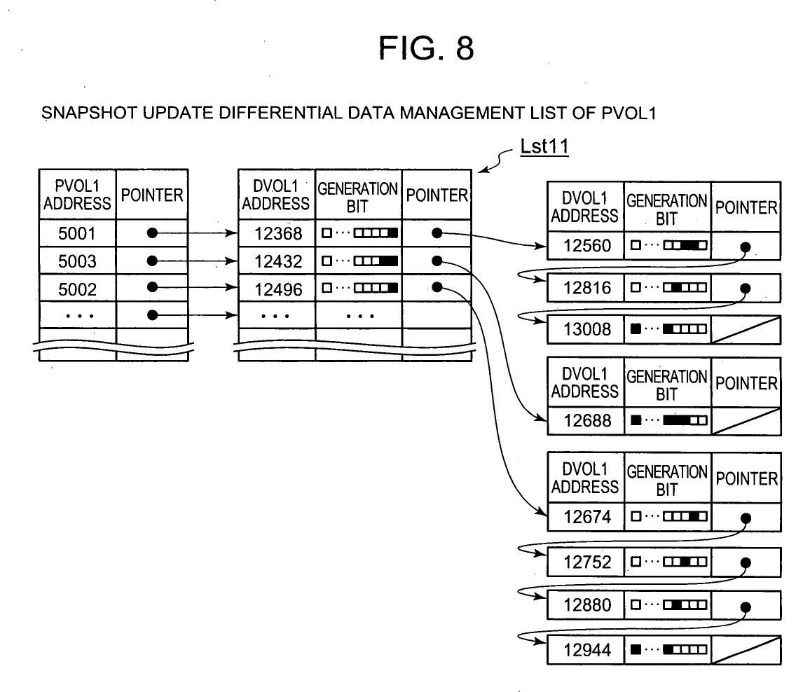

An update differential data management list of PVOL1 will be explained below with reference to FIG. 8. A Lst11 is a list for managing the update differential data of PVOL1, that is, a copy of new data. Substantially identically to the nodes in FIG. 7B, each node serves, for example, as an address of a block which is a copy destination in DVOL1, a generation bit indicating the generation of the data, and a pointer to the next node.

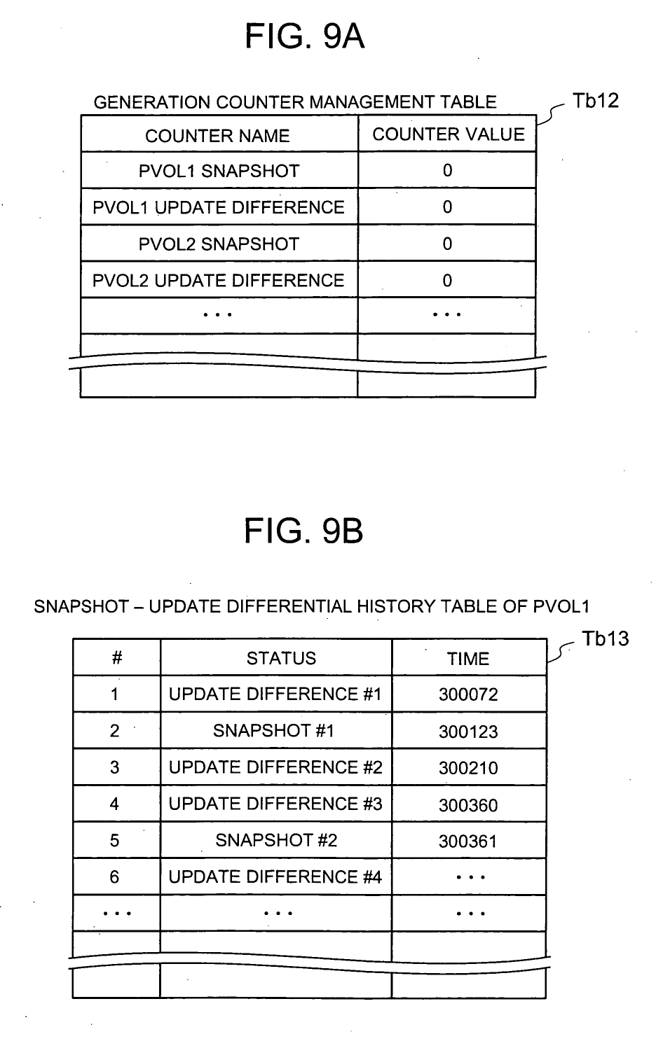

FIG. 9A shows a configuration example of a generation counter management table, which is a table for conducting generation management of snapshots and new differential data in each PVOL1, 2.

The initial value of each counter value in the generation counter management table Tb12 is zero. In the table Tb12, the counter value of the snapshot is increased by one by the control programs 118, 119 each time there is a command from the hosts 20-22, and the counter value of the update differential data is increased by one each time an opportunity is taken to provide the consistency from the hosts 20-22, e.g., a sync command. Further, a sync command can be defined as a command which is issued by an operating system (OS) like Linux (trademark) or Windows (trademark). More specifically, in the case of SCSI protocol, the sync command is issued to the disk array device as a SYNCRONIZE CACHE command or a WRITE command in which FUA (Force Unit Access) bits in the SCSI header are set ON. In the case of ATA protocol, the sync command is issued to the disk array device as a FLUSH CACHE command. Then, data remaining in the cache is transferred to the disk device according to the sync command. When the control program 118 receives the sync command, for example, the control program 118 can transfer data, which is not written in PVOL1 and exists in the cache memory 6 of the disk array controller 11, from the cache memory 6 to the PVOL 1.

Furthermore, the sync command can be issued at various timings, independently of a clear command from the user. For example, it can be issued as a write command, as in the above-described example. Furthermore, for example, a sync command can be issued as a synchronization command to ensure the sequential nature of commands when a multipath switching driver that controls a plurality of I/O paths to the same address destination (for example PVOL1) and is a computer program to be operated on the OS switches the I/O path where the command flows. Also, for example, the application can invoke a sync command from the OS to be issued periodically or aperiodically in order to give a notice of the checkpoint showing the point in time when consistency is provided.

FIG. 9B is a configuration example of a snapshot—update differential history table of PVOL1.

A snapshot—update differential history table (referred to hereinbelow simply as “history table”) Tb13 shown as an example in FIG. 9B is a table for managing the generation update history of snapshot and update differential data (copy of new data) of PVOL1 in the time axis order. If a certain generation is updated, the updated generation is recorded by the control programs 118, 119 together with updated time in the table Tb13. More specifically, for example, in the “status” column, “snapshot” or “update differential” indicate whether the updated results are the snapshot or the update differential data, and the following number “#” is a serial number. A value, e.g., of a timer provided in the disk array device 1 or disk array controllers 11, 12 can be used as the update time, but another time acquisition method can be employed, whether inside or outside the disk array device, if the order along the time axis can be guaranteed.

The bitmaps or lists shown by examples in FIG. 7A, FIG. 7B, FIG. 8, and FIG. 9B can be prepared for each PVOL.

Examples of processing flows of various types conducted by the disk array device 1 will be explained below.

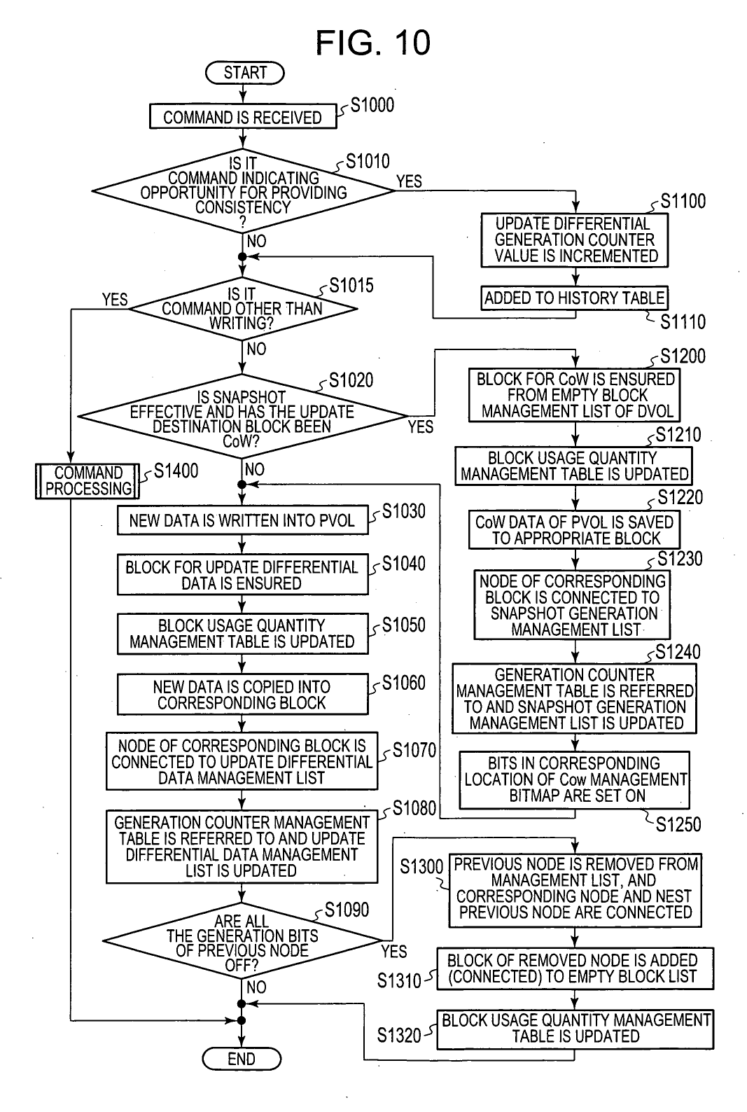

FIG. 10 is an example of a flowchart of the processing conducted when a command is received from the host. In the explanation below, the explanation of the processing flow conducted when a read command is received is omitted and only the processing conducted when a write command or a command indicating a check point arrives will be explained. The flowchart shown in FIG. 10 indicates the processing from receiving a command from the host to sending a response to the host and this processing is executed each time a command is received from the host. To facilitate he understanding of the explanation, the host 20 will be assumed as a unit sending the command, the control program 118 will be considered as a program processing the command received by the disk array unit 1, and the PVOL1 will be assumed as a writing destination of the write command.

If the control program 118 receives a command from the host 20 (step S1000), whether or not the received command is a command indicating the check point for providing the consistency is determined (step S1010).

When the command was determined in step S1010 to be other than a command indicating the check point for providing the consistency (step S1010: No), the control program 118 determines as to whether or not this command is a write command (step S1015).

When the command was determined in step S1015 to be a write command (step S1015: No), the control program 118 determines as to whether the snapshot is effective and whether the block serving as a data write destination has been saved in CoW (step S1020). Whether or not the snapshot of PVOL1 is effective can be determined, for example, by determining whether or not the counter value of the snapshot corresponding to PVOL1 is equal to or larger than 1 by referring to the generation counter management table Tb2 (the snapshot is effective if it is equal to or larger than 1). Whether or not the block has been saved in CoW can be determined, for example, by determining whether the bit corresponding to the write destination block is ON or OFF by referring to the CoW management bitmap Mp9 (when the bit is ON, the block is considered to be saved in CoW).

If a decision is made that the snapshot is effective and saving has been completed in CoW or if a decision is made that the snapshot is ineffective (counter value of the snapshot is zero) and the CoW processing is not required (step S1020: No), the control program 118 writes the new data, which is the write object, in the corresponding address (write destination address designated by the write command) on PVOL1 (step S1030). Then, the control program 118 makes a transition to a processing of writing update differential data into DVOL1.

Thus, in order to write the new differential data (copy of new data) into DVOL1, the control program 118 ensures a block serving as the write destination of the new differential data by referring to the empty block management list Lst7 (see FRIG. 6A) (step S1040). Then, the control program 118 updates the values of the block usage quantity management table Tb8 (step S1050). More specifically, the control program 118 decreases the number of empty blocks and increases the number of differential management blocks for PVOL1.

Then, the control program 118 writes the update differential data in the block on DVOL1 that was ensured in step S1040 (step S1060). Then, the control program 118 connects a node (referred to hereinbelow as the newest node) corresponding to the block that became the write destination of update differential data to the update differential data management list Lst11 (step S1070). More specifically, for example, when the control program 118 updates the data of address 5001 of PVOL1, as shown in FIG. 8, it can successively search herefrom the nodes connected with a pointer and connect the newest node to the very last node.

In step S1080, the control program 118 determines what is the order of the present generation of the update differential data of PVOL1 by referring to the generation counter management table Tb13 (in other words, the control program obtains the update differential counter value). Then, the control program 118 sets OFF all the bits following the present generation with respect to the generation bits of the node immediately preceding the newest node connected in step S1070 in the update differential data management list Lst11 of PVOL1. On the other hand, the control program 118 sets ON the bits following the present generation with respect to the generation bits of the newest node connected in step S1070. With the processing of step S1080, the generation of the block corresponding to the connected newest node can be taken as the present generation.

The control program 118 checks whether or not all the bit groups constituting the generation bits of the immediately preceding node became OFF (step S1090), and when they have not become OFF (step S1090: No), the control program returns a response to the host 20 and completes the processing.

However, when in step S1010 the command from the host 20 indicated the opportunity for providing the consistency (step S1010: Yes), the control program 118 increases by 1 the generation counter value corresponding to the update difference of PVOL1 in the generation counter management table Tb12 (step S1100) and records that the generation of the update differential data of PVOL1 has changed and the time thereof in a history table Tb13 corresponding to PVOL1. The processing of step S1015 and subsequent processing are identical to the above-described processing.

Furthermore, when the snapshot was found to be effective, but saving of data with CoW was determined to be incomplete in step S1020 (step S1020: Yes), the control program 118 ensures a block serving as a write destination of CoW data from the empty block management list LsT7 of DVOL1 (step S1200). Then, the control program 118 updates the block usage quantity management table Tb8 of DVOL1 (step S1210) in the same manner as in step 1050, and then saves (in other words, moves) the CoW data from PVOL1 into the ensured empty block located in DVOL1 (step S1220). Then, the control program 18 connects the node of the block that became the write destination of the CoW data to the snapshot generation management list Lst10 of PVOL1 as the very last node associated with the address of the update preset block in PVOL1 (address designated by the write command) (step S1230). The control program 118 then sets ON the bits from one rear bit of the bits representing the generation of the immediately preceding node to the present generation bit in the bit group of the generation bits of the newest node by referring to the generation counter management table Tb12 and the generation bit of the immediately preceding node of the connected newest mode (step S1240). As a result, the generation of the update preset block in PVOL1 can be made the present generation. Furthermore, the control program 118 also sets ON (=saved) a bit corresponding to the update preset block in PVOL1 in the CoW management bitmap Mp9 of PVOL1. The processing of step S1030 and subsequent steps are identical to the above-described processing.

In step S1090, when all the generation bits of the immediately preceding node of the connected newest mode became OFF (step S1090: Yes), it means that the new data were overwritten while no consistency was provided. For this reason, the immediately preceding node is not required. Therefore, the control program 118 can free the immediately preceding node by the following procedure. Thus, the control program 118 removes the immediately preceding node from the list and changes the pointer of the node before the immediately preceding node so that it indicates the newest node (step S1300). In other words, the newest node is connected to the node preceding the removed immediately preceding node. The control program 118 adds the address of the block held by the removed immediately preceding node to the empty block management list Lst7 (step S1310). Then, the control program 118 decreases the number of differential management blocks for PVOL1 in the block usage quantity management table Tb8 and increases the number of empty blocks correspondingly to the removed quantity (step S1320). The unnecessary blocks are freed by the above-described procedure and can be reused.

Furthermore, if there is a command other than the write command in step S1015, the processing is conducted according to this command (step S1400).

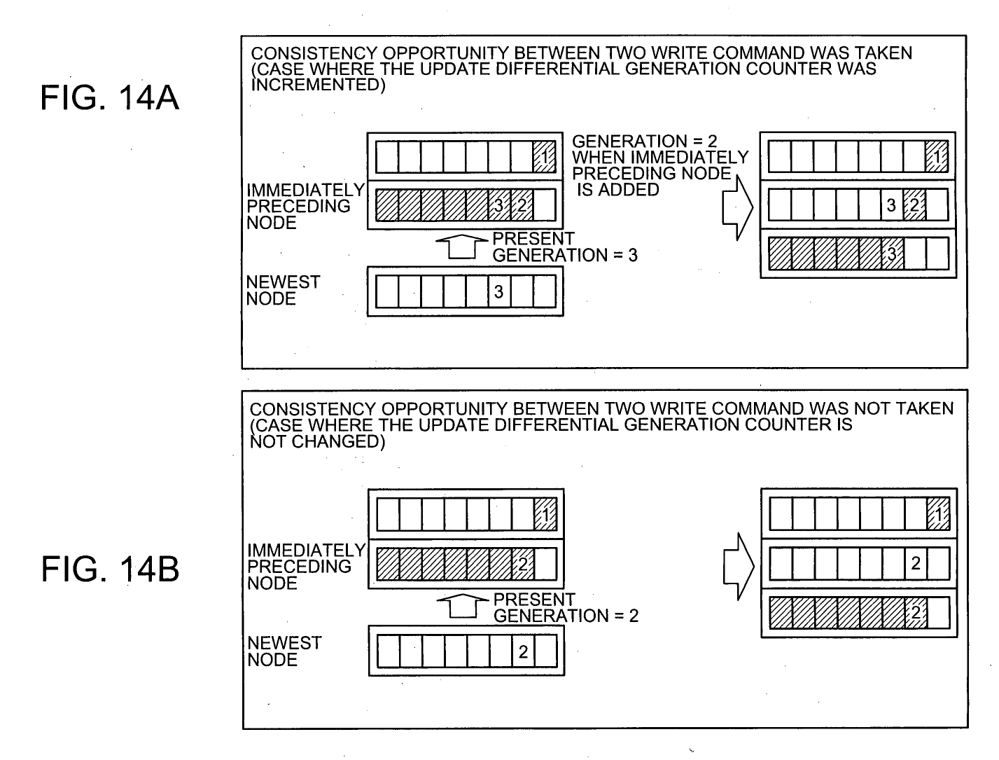

The explanation hereinabove was conducted with reference to FIG. 10. The explanation relating to the case where a “Yes” decision is made in step S1090 will be provided below with reference to FIG. 14A and FIG. 14B. In FIG. 14A and FIG. 14B, each node represents a node in the update differential data management list Lst11. The frame arranged in the node represents a bit constituting the generation bit and a digit in the frame represents the generation.

For example, when there was a command indicating the consistency opportunity between the write commands (for example, when a certain write command and the next received write command were sync commands), in step S1010, the update differential generation counter is incremented. As a result, as shown by way of an example in FIG. 14A, the generation in the newest mode becomes the generation (for example, 3) next to the generation (for example, 2) in the immediately preceding node.

However, when there was no command indicating the consistency opportunity between the write commands (for example, when a certain command was not a sync command, but the next received write command was a sync command), in other words, when data were written anew without providing the consistency, the update differential generation counter is not incremented in step S1010. Thus, as shown in FIG. 14B, the generation in the immediately preceding node (for example, 2) and the generation in the newest node become identical (for example, 2).

At this time, in the processing of step S1080, the control program 118 turns OFF all the bits after the present generation (=2, 3, 4 . . . ) of the immediately preceding node and turns ON all the bits after the present generation (=2, 3, 4 . . . ) of the newest mode. Therefore, as shown by way of an example in FIG. 14B, all the bits of the immediately preceding node assume an OFF state. As a result, a state is assumed in which the data of the effective (that is, the bit is ON) second generation and the data of the ineffective (that is, the bit is OFF) second generation that was overwritten are held as the update differential data. For this reason, the ineffective immediately preceding node can be freed by conducting the processing of steps S1300 to S1320 following the Yes in step 1090.

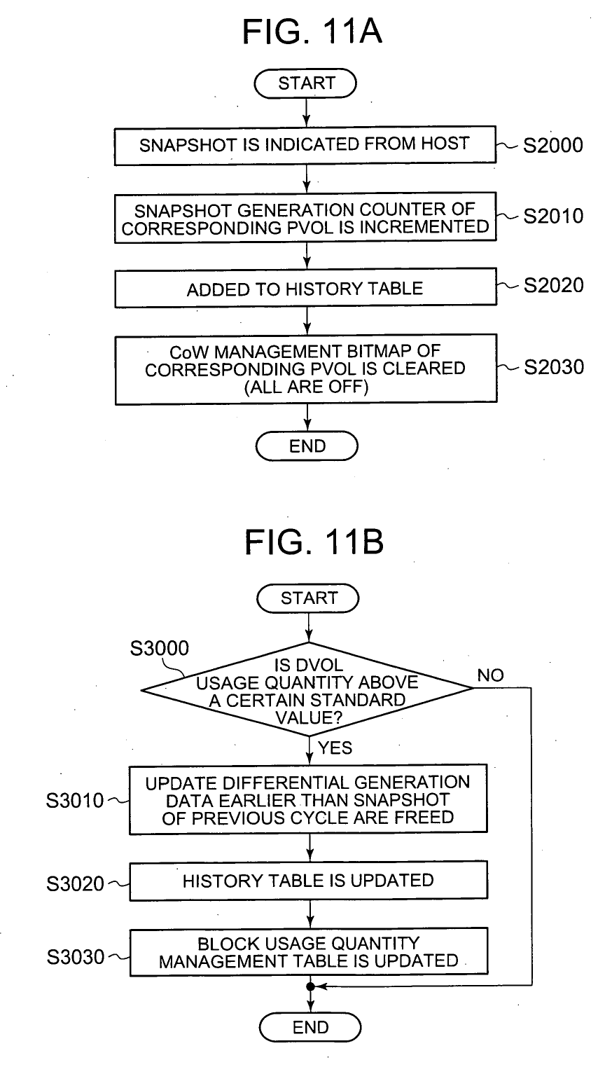

FIG. 11A shows an example of a flowchart of the processing conducted when a snapshot command is received from a snapshot manager 202 of host 20.

For example, if the control program 118 receives a command instructing to take a snapshot of PVOL1 from the snapshot manager 202 in host 20 (step S2000), a counter value corresponding to the snapshot generation in PVOL1 is increased by 1 in the generation counter management table Tb12 (step S2010). Furthermore, the control program 118 records the update time and that the snapshot was updated in the history table Tb13 of PVOL1 (step S2020). Then, the control program 118 clears (all OFF) all the CoW management bitmaps MP9 of PVOL1 (step S2030).

FIG. 11B shows an example of a flowchart of the processing conducted to decrease the usage quantity of DVOL by removing the section where the update differential data and CoW data overlap.

The processing of this flowchart is executed by the control program 118, for example, when a snapshot command is received from the host 20. Thus, if a snapshot command is received, the control program 118 checks whether or not the usage quantity of DVOL1 exceeds the prescribed standard value by referring to the block usage quantity management table Tb8 of DVOL1 (step S3000). This standard value, for example, can be stored in the memory of the disk controller 11. The standard value can be set by the user via the management terminal 31. The standard value may be also set not by the user. In this case, the control program 118 may operate in a mode of using a standard value that was prepared in advance as an initial value or in a mode in which the flowchart shown in FIG. 11B is periodically executed and the duplicated data are deleted if possible.

When the usage quantity is equal to or larger than the standard value (step S3000: Yes), the control program 118 frees the update differential generation data (step S3010) of the generation prior to the generation of the snapshot taken in the immediately preceding cycle (generation represented by the counter value after incrementing in step S2010). Thus, the control program 118 frees from DVOL1 the update differential data written into DVOL1 prior to the standard time of the snapshot which is two generations before the snapshots for which the opportunity of conducting the processing of FIG. 11B was taken. More specifically, for example, the control program 118 specifies the generation of the freed update differential data by referring to the history table Tb13. For example, if the chance to start the present processing is considered as a third-generation snapshot in the history table Tb13 shown in FIG. 9B, the snapshot that is two generations before will be “snapshot #1”. The update differential taken prior to “snapshot #1” will be “update differential #1”. Therefore, it is clear that the first-generation update differential data are the object of freeing from DVOL1.

After the update differential data of this generation (two generations before the generation of the newest snapshot) has been freed from DVOL1, the control program 118 frees the “update differential #1” item freed from the history table (step S3020). The node of the freed update differential data is also freed from the list Lst11 (see FIG. 8), and the block usage quantity management table is updated (step S3030).

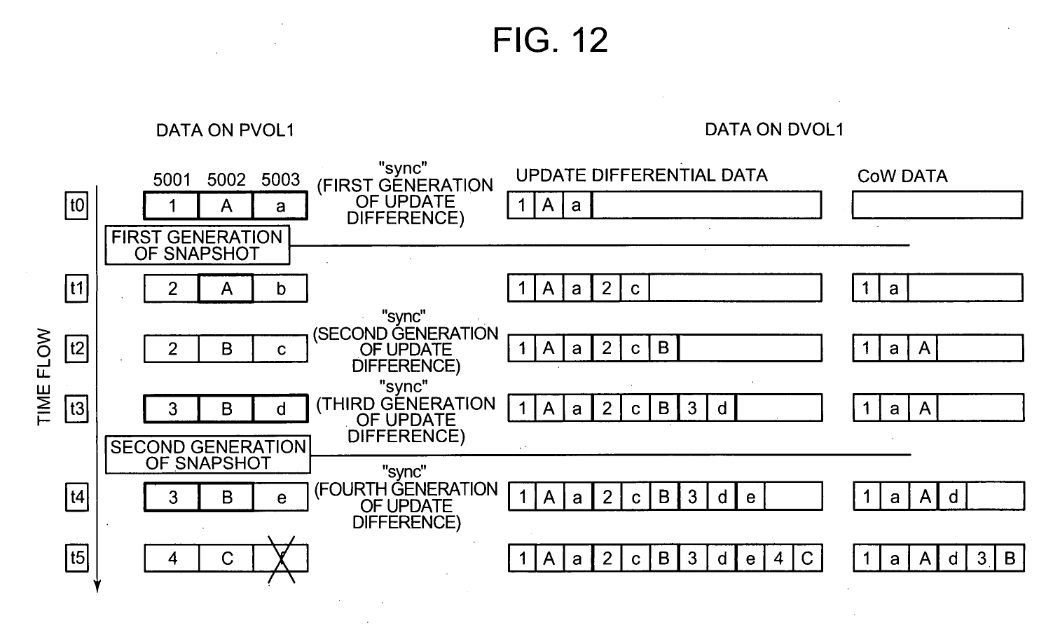

FIG. 12 illustrates schematically the change in data with time on PVOL1 and DVOL1, this figure facilitating the understanding of the processing flows shown in FIG. 10, FIG. 11A, and FIG. 11B.

In FIG. 12, t0, t1, . . . of the ordinate represent time at each point in time, and “data on PVOL1” of the abscissa represent data in the block addresses 5001, 5002, 5003. Similarly, “data on DVOL1” of the abscissa represent the pattern of update differential data and CoW data.

If data “1”, “A”, “a” are written in the block addresses 5001, 5002, 5003, respectively, on PVOL1 at a time instant t0, then update differential data “1”, “A”, “a” are written on DVOL1 by the processing shown in FIG. 10 (see steps S1030 to 1080). Furthermore, at the same time, a “Sync” command, which is one of opportunities to provide the consistency, was issued. Therefore, the generation of the update differential rises by one (in other words, the counter value of the update differential corresponding to PVOL1 changes from 0 to 1 (and the update differential data of the first-generation are set (see: steps S1010, S1100, S1110).

If a snapshot command is received prior to a time instant t1, the data of PVOL1 at the time instant t0 is protected with a snapshot by the processing shown in FIG. 11A.

If then a write command for writing “2” and “b” into the block addresses 5001, 5003, respectively is issued at the time instant t1, then “1” and “a” are saved as CoW data and “2” and “b” are recorded as update differential data by repeating the processing (see: steps S1000-1090) shown in FIG. 10. Furthermore, the data on PVOL1 are also updated as shown in FIG. 12.

Then, if a write command for rewriting “B”, “c” to the block addresses 5002, 5003, respectively, is issued at a time instant t2, then “A” is saved as the CoW data by the processing shown in FIG. 10. Furthermore, there was no “Sync command” at the time instant t1 immediately preceding the time instant t2, the update differential data “b” is freed and “c”, “B” are recorded as update differential data by the processing of steps S1090 and S1300-1320 at the time instant t2. In other words, in the case that was not an opportunity to provide the consistency of data or an immediately preceding time instant, the control program 118 frees from DVOL1 the update differential data “b” identical to data “b” prior to overwriting in PVOL1 at the present time instant t2 and also does not save the data “b” present on PVOL1 as CoW data in DVOL1. At this time instant t2, the update differential data of the second-generation are set by the issuance of “Sync command”.

Then, if a write command for writing “3”, “d” in blocks 5001, 5003, respectively, is issued at a time instant t3, then “3”, “d” are recorded as update differential data on DVOL1. On the other hand, because CoW data have already been saved with respect to those blocks 5001, 5003 (in other words, CoW has been conducted at the time instant t1), no CoW occurs at this time instant t3. The update differential data of the third-generation are set at the time instant t3 by the issuance of “Sync command”.

Before a time instant t4, the image of PVOL1 at the time instant t3 is protected as a snapshot by the second snapshot command. As a result, all the bits of the CoW management bitmap Mp9 of PVOL1 are made OFF.

If a command for writing data “e” into block 5003 is issued at the time instant t4, then “d” is saved as CoW data from PVOL1, “e” is recorded as update differential data on DVOL1, and data of PVOL1 are updated. Furthermore, the update differential data of the fourth-generation are set by the “Sync command” at the same time instant t4.

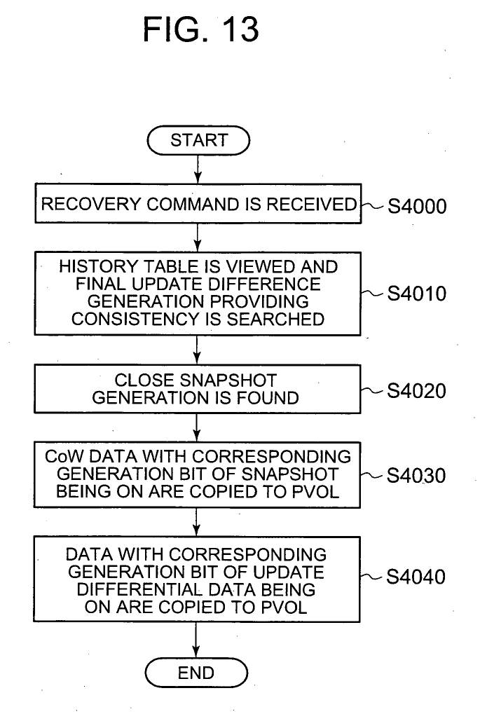

The recovery control will be explained with reference to FIG. 13. FIG. 13 shows an example of a processing flowchart for recovering data to a closest state with provided consistency that is conducted to recover data that became inconsistent because an accident has occurred. This processing can be executed when a command is issued by the user. The command can be issued from the hosts 20, 21, 22 or the management terminal 31.

For example, if the control program 118 receives a PVOL1 recovery command from the host 20, (step S4000), it searches for a snapshot generation immediately preceding the update differential final generation for which the consistency was provided, by referring to the history table Tb13 corresponding to PVOL1 (steps S4010, S4020). The “update differential final generation” is the generation of update differential data at the closest point in time where the consistency of update differential data was provided.

Then the control program 118 specifies the address on DVOL1 corresponding to the generation bit representing this snapshot generation from the snapshot generation list Lst10 and returns the CoW data present in the block with the specified address from DVOL1 to PVOL1 (step S4030).

After the snapshot recovery has been completed, the control program 118 specifies from the update differential data management list Lst11 the address on DVOL1 corresponding to the generation bit representing the aforementioned update differential final generation and returns the update differential data present in the block with the specified address from DVOL1 to PVOL1 (step S4040).

The above-described processing completes the recovery. Conducting explanation with reference to FIG. 12, for example, let us assume that a recovery command is received when a damage occurred in PVOL1 at a time instant t5 in a state where data “4”, “C”, “f” are present in PVOL1. As a result, because the processing of the above-described step S4010 and S4020 is conducted, it is clear that the update differential final generation is the fourth-generation and the snapshot generation close thereto is the second-generation. The control program 118 searches the address in DVOL1 of the generation bit representing the second generation as the snapshot generation from the snapshot generation management list Lst10 and returns the CoW data “3”, “B”, “d” present at this address from DVOL1 to PVOL1. Then, the control program 118 searches the address in DVOL1 of the generation bit representing the fourth-generation as the update differential final generation from the update differential data management list Lst11 and returns the update differential data “e” present at this address from DVOL1 to PVOL1. As a result, the data “3”, “B”, “e” at the point in time where the differential update final generation is the fourth generation is recovered in PVOL1.

With the above-described embodiment, in addition to a clear command from the user (in other words, manual command from the user), the opportunity of providing the consistency of data is taken and update differential data are confirmed with this opportunity. Therefore, data protection with a fine time grain size is possible without increasing a load on the host.

Furthermore, with the above-described embodiment, the PVOL at the point in time of the update differential final generation, that is, at the point in time the consistency was provided is recovered by a first step of returning CoW data of the snapshot generation that is the closest generation preceding the update differential final generation, of a plurality of data present in the DVOL, to the PVOL and then a second step of returning the update differential data of the update differential final generation to the PVOL. As a result, the recovery can be expected to be faster than sequential restoration of data, for example, as in the conventional journaling technology.

Furthermore, with the above-described embodiment, a copy of new data is generated and written as update differential data into the DVOL. With CoW, the access to the PVOL is generated, that is, data are read from the PVOL, but in the present embodiment, the copy of new data is prepared and written into the DVOL each time the new data is written into the PVOL. Therefore, data protection with a fine time grain size is possible without creating an access load to the PVOL (in other words, without degrading the access capability to the PVOL).

Furthermore, with the above-described embodiment, whether or not the update differential data and CoW data overlap in the DVOL is determined at the prescribed timing, and if the duplication is found to be present, one of the data is deleted and the other is left. As a result, the amount of consumption of the DVOL can be reduced.

The preferred embodiment of the present invention was explained above, but it was merely an example illustrating the present invention and should not be construed as limiting the scope of the present invention to this embodiment. The present invention can be also implemented in a variety of other modes.

For example, the DVOL may be prepared on the memory of the disk array controller 11, instead of or in addition to the disk device. In this case both the update differential data and the CoW data may be written into the memory, or one may be written into the memory and the other may be written into the disk device.

Furthermore, for example, the DVOL may be divided into an area for storing the update differential data and an area for storing the CoW data.

What is claimed is:

1. A storage system comprising:
a first logical volume into which data from a host computer are written;
a second logical volume, which is a logical volume for backup of said first logical volume; and
a controller for writing data following a write command from said host computer into said first logical volume, wherein
said controller:
manages a snapshot generation, which is the generation of a snapshot at each point in time when the snapshot is taken;
updates said snapshot generation for each occurrence of point in time when the snapshot is taken;
determines whether or not a write destination of new data is the location that has become the write destination for the first time after said point in time when the snapshot is taken in cases where said new data are written into said first logical volume from the point in time when the snapshot has been taken until the next point in time when the snapshot is taken, and if the write destination is a location that has become the write destination for the first time, saves the old data that have been stored in said write destination from said write destination of said first logical volume into said second logical volume, and writes said new data into said write destination;
writes update differential data, which is a copy of said new data, into said second logical volume each time new data are written into said first logical volume;
takes an opportunity to provide the consistency of said first logical volume occurring independently of the operation of the user of said host computer;
manages an update differential generation, which is the generation of said update differential data at each point in time when said update differential data is set;
updates said update differential generation each time said opportunity is taken; and
conducts recovery of said first logical volume based on said managed update differential generation and snapshot generation.

2. The storage system according to claim 1, wherein said opportunity that is taken is a sync command issued from the operating system of said host computer.

3. The storage system according to claim 1, wherein
said controller:
manages said snapshot generation and the update sequence of said update differential generation;
manages in which snapshot generation each said saved old data has been saved;
manages in which update differential generation each said written update differential data has been written;
selects the update differential generation, which becomes the recovery object, from a plurality of the update differential generations that are managed;
selects a snapshot generation immediately preceding said selected update differential generation from one or more said snapshot generations that are managed;
determines said old data saved in said selected snapshot generation;
determines said update differential data written in said selected update differential generation; and
recovers data located in said first logical volume at the point in time of updating in said selected update differential generation by transferring said determined old data from said second logical volume to said first logical volume and then transferring said determined update differential data from said second logical volume to said first logical volume.

4. The storage system according to claim 2, wherein
said controller receives a recovery command from said host computer or a separate computer and takes a recovery object as an update differential generation after updating at the point in time which is the closest to the point in time when said recovery command has been received.

5. The storage system according to claim 1, wherein
said controller determines whether or not said old data present in said second logical volume and said update differential data are identical, and deletes one data from said second logical volume if both are identical.

6. The storage system according to claim 4, wherein said controller deletes the update differential data when said data are identical.

7. The storage system according to claim 1, wherein said controller receives a snapshot taking command from said host computer or another computer by manual operations, and takes the point in time when said snapshot taking command is received as the point in time when the snapshot is taken.

8. A storage control method comprising the steps of:
writing data following a write command from a host computer into a first logical volume;
updating a snapshot generation, which is the generation of snapshot at each point in time when the snapshot is taken, for each occurrence of the point in time when the snapshot is taken;
determining whether or not a write destination of new data is the location that has become the write destination for the first time after said point in time when the snapshot is taken in cases where said new data are written into said first logical volume from the point in time when the snapshot has been taken until the next point in time when the snapshot is taken, and if the write destination is the location that has become the write destination for the first time, saving the old data that have been stored in said write destination from said write destination of said first logical volume into said second logical volume, and writing said new data into said write destination;
writing update differential data, which is a copy of said new data, into a second logical volume, which the logical volume for backup of said first logical volume each time new data are written into said first logical volume;
taking an opportunity to provide the consistency of said first logical volume that occurred independently of the operations of the user of said host computer;
updating update differential generation, which is the generation of said update differential data at each point in time when said update differential data is set, each time said opportunity is taken; and
conducting the recovery of said first logical volume based on said managed update differential generation and snapshot generation.

9. A computer program for causing a computer to execute the steps of:
writing data following a write command from a host computer into a first logical volume;
updating a snapshot generation, which is the generation of snapshot at each point in time when the snapshot is taken, for each occurrence of the point in time when the snapshot is taken;
determining whether or not a write destination of new data is the location that has become the write destination for the first time after said point in time when the snapshot is taken in cases where said new data are written into said first logical volume from the point in time when the snapshot has been taken until the next point in time when the snapshot is taken, and if the write destination is a location that has become the write destination for the first time, saving the old data that have been stored in said write destination from said write destination of said first logical volume into said second logical volume, and writing said new data into said write destination;
writing update differential data, which is a copy of said new data, into a second logical volume, which is a logical volume for backup of said first logical volume each time new data are written into said first logical volume;
taking an opportunity to provide the consistency of said first logical volume that occurred independently of the operations of the user of said host computer;
updating update differential generation, which is the generation of said update differential data at each point in time when said update differential data is set, each time said opportunity is taken; and
conducting the recovery of said first logical volume based on said managed update differential generation and snapshot generation.

10. A storage system comprising:
a first logical volume into which data from a host computer are written;
a second logical volume, which is a logical volume for backup of said first logical volume; and
a controller for writing data following a write command from said host computer into said first logical volume, wherein
said controller:
receives a snapshot taking command from said host computer or another computer by manual operations;
manages a snapshot generation at each point in time when the snapshot is taken, which is the point in time when said snapshot taking command has been received;
updates said snapshot generation for each occurrence of point in time when the snapshot is taken;
determines whether or not a write destination of new data is the location that has become the write destination for the first time after said point in time when the snapshot is taken in cases where said new data are written into said first logical volume from the point in time when the snapshot has been taken until the next point in time when the snapshot is taken, and if the write destination is the location that has become the write destination for the first time, saves the old data that have been stored in said write destination from said write destination of said first logical volume into said second logical volume, and writes said new data into said write destination;
writes update differential data, which is a copy of said new data, into said second logical volume each time new data are written into said first logical volume;
takes an opportunity to provide the consistency of said first logical volume occurring independently of the operation of the user of said host computer;
manages an update differential generation, which is the generation of said update differential data at each point in time when said update differential data is set;
updates said update differential generation each time said opportunity is taken;
manages the update sequence of said snapshot generation and said update differential generation;
determines whether or not said old data present in said second logical volume and said update differential data are identical and deletes one data from said second logical volume if both are identical;
manages in which snapshot generation each said saved old data has been saved;
manages in which update differential generation each said written update differential data has been written;
selects a snapshot generation immediately preceding said selected update differential generation from one or more said snapshot generations that are managed;
determines said old data saved in said selected snapshot generation;
determines said update differential data written in said selected update differential generation; and
recovers data located in said first logical volume at the point in time of updating in said selected update differential generation by transferring said determined old data from said second logical volume to said first logical volume and then transferring said determined update differential data from said second logical volume to said first logical volume.
